(19) United States
(12) Patent Application Publication
(10) Pub. No.: US 2012/0030020 A1
(43) Pub. Date: Feb. 2, 2012

(54) COLLABORATIVE FILTERING ON SPARE DATASETS WITH MATRIX FACTORIZATIONS

(75) Inventors: Serhat S. Bucak, Haslett, MI (US); Jianying Hu, Bronx, NY (US); Aleksandra Mosjilovic, New York, NY (US); Vikas Sindhwani, Hawthorne, NY (US)

(73) Assignee: INTERNATIONAL BUSINESS MACHINES CORPORATION, Armonk, NY (US)

(21) Appl. No.: 12/848,602

(22) Filed: Aug. 2, 2010

(51) Int. Cl. G06Q 30/00

(52) U.S. Cl. 705/14.53

(57) ABSTRACT

A system, method and computer program product automatically present at least one product to at least one client for at least one possible purchase. The system applies a matrix factorization on a binary matrix X representing which clients purchased which products. The system optimizes zero-valued elements in the matrix X that correspond to unknown client-product affinities. The system constructs based on the optimization, a prediction matrix \hat{X} whose each element value represents a likelihood that a corresponding client purchases a corresponding product. The system identifies at least one client-product pair with the highest value in the matrix \hat{X}. The system recommends at least one product to at least one client according to the client-product pair with the highest value.

### BACKGROUND

The present invention generally relates to recommending a product to a client. More particularly, the present invention relates to a system and method for analyzing clients' purchase history to recommend products to the clients.

A multinational IT organization (e.g., IBM®, etc.) sells a variety of products to a number of clients. The products are diverse ranging from hardware and software to business intelligence and cost-saving services. The clients are typically distributed globally, covering a diverse range of firmographics characteristics. In such a global business environment, there arises a need to make data-driven decisions on where to allocate sales resources. A model that can analyze historical purchase patterns of existing clients and make useful recommendations to sellers and marketers as to which clients might be targeted next with what products can add immense value not only from a perspective of day-to-day selling but also in terms of supporting a long term (e.g., more than 1 year, etc.) business strategy formation by providing an accurate and dynamic view of opportunities that are likely to enter the sales pipeline once the recommendations are followed.

A corporate database stores purchase data including, without limitation, information of a particular client that had purchased a particular product on a particular date, etc. The database may represent this data as an m×n binary matrix where one-valued entries represent purchases and zero-valued entries represent products not yet purchased by corresponding clients over corresponding products. Knowledge of clients and products is typically spread in a diffused manner over an entire business organization. It is therefore highly desirable to have an ability to make sales recommendations without a manual involvement or without painstaking management of rapidly changing client and product profiles.

Given historical records of client purchases, compactly represented as a sparse binary matrix (i.e., a binary matrix whose row represents clients and whose column represents products and whose value represent whether a corresponding client purchased a corresponding product), a real-world recommender system, e.g., for an Information Technology (IT) company, provides recommendations for what products might be sold next to existing clients, e.g., to increase sales and/or customer relationship. Such a recommender system may be formulated as a collaborative filtering task. Collaborative Filtering (CF) refers to a class of techniques used in recommender systems that recommend items to users that other users with similar tastes have liked in the past. The process of recommendation may be likened to a form of item filtering, while the use of data from other users may be likened to a form of “collaborative” analytics. John S. Breese, et al., “Empirical Analysis of Predictive Algorithms for Collaborative Filtering”, Technical Report of Microsoft Research in Microsoft Corporation, May, 1998, wholly incorporated by reference as if set forth herein, describes the collaborative filtering in detail. Collaborative filtering has been a choice for designing such a recommender system since it generates recommendations by analyzing the data matrix alone. However, the performance of collaborative filtering systems depends on the number of observed entries in the data matrix. Moreover, most existing techniques do not work well on highly sparse datasets and do not apply to one-class problems such as sales recommendation problems where one-valued entries specify a purchase, but zero-valued entries do not necessarily imply that a corresponding client has a low propensity to buy that product at some point in the future.

Netflix® conducted a million dollar contest for a design of a recommender system for its movie recommendation. Concluded in 2009, this contest demonstrated that Matrix Factorization techniques are the state of the art methodology for collaborative filtering. When thinking of applying matrix factorization techniques to the sales recommendation problem, it is evident that it is quite different from movie recommendation problem faced by Netflix®. In Netflix®, a user-movie matrix may comprise different kinds of entries, ranging from five (stars) expressing strong preference to one (star) expressing no interest or dislike, and zero for unrated movies that may be considered as missing data to be estimated. In contrast, the sales recommendation generates one-class datasets (e.g., binary data, etc.) since the business knowledge for negative examples—that a client has no interest in buying a product ever in the future—is typically not available in the corporate databases. Moreover, such knowledge is difficult to gather and maintain in the corporation, given the rapidly changing business environment, and rapidly changing client tendencies to purchase a product.

A low-rank matrix factorization approach starts with an assumption that there exists a small number k (e.g., an integer number less than 100, etc.) of latent factors that can explain buying behaviors of clients. A low-rank matrix factorization is a method for constructing a low-rank approximation (LRA) to a matrix. The quality of the approximation is measured by using a norm (e.g., Frobenius norm, etc.) on the difference between the original matrix and its approximation. Robert Bell, et al., “Matrix Factorization Techniques for Recommender Systems”, IEEE Computer Society, 2009, volume 42 (8), wholly incorporated by reference as if set forth herein, describes the matrix factorization in detail in the context of recommender systems. Carl Meyer, Matrix Analysis and Applied Linear Algebra, SIAM 2001, ISBN: 0-89871-454-0, page 279, wholly incorporated by reference as if set forth herein, described the Frobenius norm in detail. Clients and Products are represented as feature vectors in these latent factors, where similarity between a client-product pair models a propensity of a corresponding client to buy a corresponding product. While exact interpretability of latent factors is not easy, they implicitly capture attributes such as firmographics for clients (e.g., size, turn-over, industry sector, etc.) or “bundles” for product (e.g., packaged solutions combining hardware, software and services, etc.).

Use of collaborative filtering alone may predict preferences of clients (“users”) over a range of products (“items”) based on observations of prior purchases. The collaborative filtering may be modified to incorporate attributes representing characteristics (e.g., an amount, frequency, etc.) of the prior purchases. In a matrix factorization technique for the collaborative filtering, a client and a product are represented as unknown feature vectors w, hεR^{k} whose dimensions are considered as k latent factors. These feature vectors are learned, e.g., by the matrix factorization, so that an inner product w^{T}h matches preference ratings of the client as shown in FIG. 4. In FIG. 4, values of the inner products 410 represent values of elements in the preference matrix 400. This learning of such feature vectors enables building an approximation of a client-product matrix (i.e., a matrix representing at least one relationship between at least client and at least one product). Various models are defined by a choice of approximation criteria or a loss function they employ and variants may be derived, e.g., by adding different kinds of regularization to avoid overfitting. In statistics, a loss function represents a loss associated with an estimate being “wrong” (different from either a desired or a true value) as a function of a measure of a degree of wrongness (e.g., the difference between the estimated value and the true or desired value). Regularization refers to introducing an additional information (e.g., an additional term in a formula) in order to prevent overfitting.

Non-negative Matrix Factorization (NMF) imposes a non-negativity constraint on the latent factors and the purchase data. A purchase history of each client may be approximated as a mixture of product (latent) groups, i.e., basis vectors representing latent product factors. The non-negativity constraints may lead to a “parts-based” interpretation of a preference prediction (e.g., predicting whether a particular client is interested in a particular product) based on the collaborative filtering. When NMF is applied to a matrix whose rows/columns are representations of objects, the latent factors may be viewed as frequently occurring “parts” in the object collection. NMF is designed to find such parts and also how to compose these parts in order to reconstruct each object approximately. Other matrix factorization techniques that do not impose non-negativity do not generally allow this parts-based interpretation since factors can also be subtracted out. NMF allows an additive combination of parts which leads to improve interpretability of a preference prediction.

### SUMMARY OF THE INVENTION

The present invention is a system, method and computer program product for automatically recommending a product to a client for a possible future purchase.

In one embodiment, there is provided a system for automatically presenting at least one product to at least one client for at least one possible purchase. The system includes a memory device and a processor connected to the memory device. The system applies a matrix factorization on an original client-product matrix X resulting in two low-rank factors, a client matrix W representing clients and a product matrix H representing products. The system optimizes zero-valued elements in the matrix X that correspond to unknown client-product affinities. The system constructs, based on the optimization, a prediction matrix \hat{X} whose each element value represents a likelihood that a corresponding client purchases a corresponding product. The system identifies at least one client-product pair with a highest value in the matrix \hat{X}. The system recommends at least one product to at least one client according to the client-product pair with the highest value.

In a further embodiment, the matrix \hat{X} is constructed by multiplying the client matrix W and the product matrix H.

In a further embodiment, the system formulates a first objective function representing the optimization. The first objective function includes terms: the matrix W, the matrix H, and discrete variables that represent one-valued elements and the zero-valued elements in the matrix X. The system minimizes this first objective function.

In a further embodiment, to optimize the zero-valued elements in the matrix X, the system applies a label switch procedure to the discrete variables to satisfy the constraint. The label switch procedure switches values of two different discrete variables if a certain condition associated with the two different discrete variables is met. The system optimizes the matrices W and H by keeping label variables in the first objective function fixed and solving a weighted NMF for different loss functions and regularizers.

In a further embodiment, to optimize the zero-valued elements in the matrix X, the system relaxes the first objective function by replacing the discrete variables in the first objective function with probability variables (i.e., variables whose values are probabilities). The system solves the first objective function for the probability variables in the first objective function by keeping the matrices W and H fixed and using a non-linear root-finding procedure. The system optimizes the matrices W and H by keeping label variables in the first objective function fixed and solving a weighted NMF for different loss functions and regularizers.

### BRIEF DESCRIPTION OF THE DRAWINGS

The accompanying drawings are included to provide a further understanding of the present invention, and are incorporated in and constitute a part of this specification.

FIG. 1 is a flow chart illustrating method steps for automatically presenting a product to a client for a possible purchase in one embodiment.

FIG. 2a is a flow chart illustrating method steps for optimizing of zero-valued elements in an original client-product matrix in one embodiment.

FIG. 2b is a flow chart illustrating method steps for optimizing of zero-valued elements in an original client-product matrix in another embodiment.

FIG. 2c is a flow chart illustrating method steps for deterministic annealing technique in one embodiment.

FIG. 3 illustrates an exemplary hardware configuration for implementing the flow charts depicted in FIGS. 1-2 in one embodiment.

FIG. 4 illustrates an exemplary matrix factorization for one-class collaborative filtering in one embodiment.

FIG. 5 illustrates exemplary smoothing functions in one embodiment.

FIG. 6 illustrates exemplary latent factors (exemplary clients and exemplary products) generated by Matrix Factorization in one embodiment.

FIG. 7 illustrates exemplary hinge loss functions in one embodiment.

FIGS. 8-9 illustrate algorithms in one embodiment.

### DETAILED DESCRIPTION

Given a matrix representing a prior purchase history of clients/customers, since a business organization truly does not know a status of an interest of a client in a product that (s)he has yet not purchased, the organization may choose to completely ignore unknown client-product pairs or assume that the affinity between such pairs is low, i.e., no potential future transaction between such pairs. Both of these options are sub-optimal relative to a strategy of treating these pairs as optimization variables (i.e., a variable to be optimized). These optimization variable(s) may be computed simultaneously or sequentially with latent factors (e.g., a client matrix W representing clients and a product matrix H representing products), e.g., by using a weighed NMF technique or other matrix factorization techniques for the latent factors. This simultaneous computing may bring an advantage of learning discriminative latent factors, while simultaneously attempting to assign labels. Discriminative latent factors refer to characteristics of groups/sets within data (e.g., client-product pairs, etc.). For example, users can be grouped into a number of sets according to user purchase characteristic (e.g., “users who buy comedy movies”, “users who buy drama but do not buy comedy” etc). The factors that are used to model such groups are referred as discriminative latent factors since they are not known prior and are hidden (latent) in some sense. A label refers to a (numerical) value that defines an association between a product and a client. For example, if a client buys (or “is interested in”) a product, a corresponding client-product pair is labeled by “1.” However, if a client does not buy (or “is not interested in”) a product, then a corresponding client-product pair is labeled by 0. An objective function for the optimization therefore has continuous latent variables and discrete label variables. The optimization can be performed, e.g., by using deterministic annealing technique. Deterministic annealing technique is an approach to solve combinatorial optimization problems where discrete variables are replaced by real-valued probability variables and a sequence of progressively harder optimization problems are solved while avoiding suboptimal local minima. Kenneth Rose, “Deterministic Annealing for Clustering, Compression, Classification, Regression and Related Optimization Problems”, Proceedings of the IEEE, 1998, wholly incorporated by reference as if set forth herein, describes the deterministic annealing method in detail.

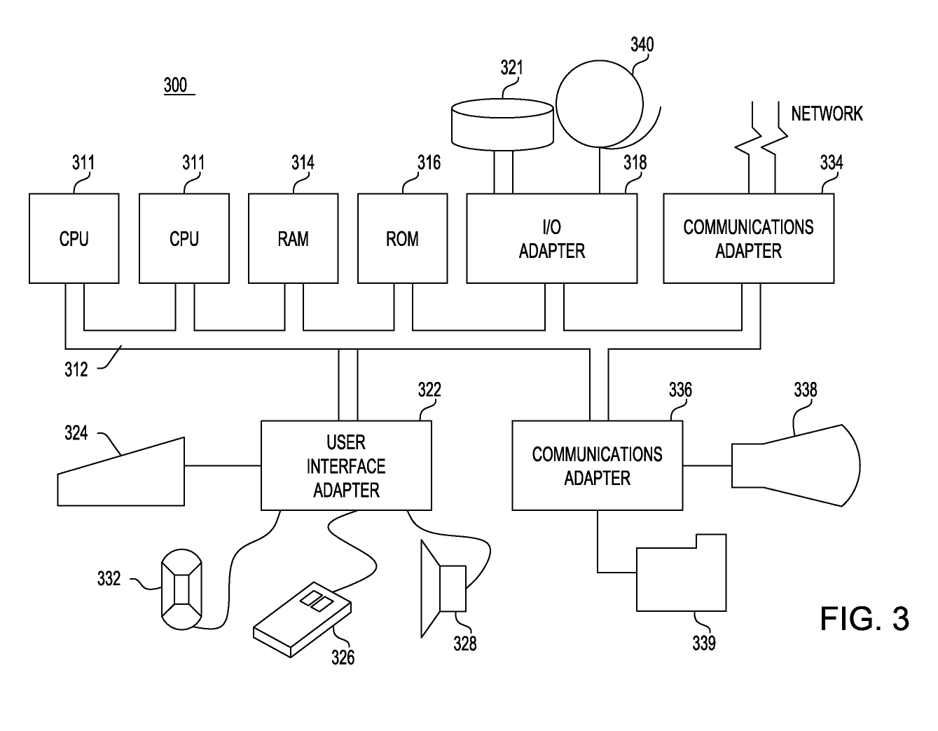

A computing system (e.g., a computing system 300 shown in FIG. 3) optimizes the optimization variables, e.g., by using an alternating optimization. An alternating optimization refers to a repeating procedure for minimizing a function jointly over all variables in the function by alternatively minimizing the function over individual subsets of the variables. Specifically, through a subroutine, the computing system applies a weighted NMF optimization technique on the client-product matrix X to optimize a client matrix W (i.e., a matrix representing identities of clients) and a product matrix H (i.e., a matrix representing names of products) while keeping the label variables in a corresponding objective function fixed. The weighted NMF optimization may include multiplicative update steps which are described below. Other NMF optimization may be used for this subroutine. The computing system may add regularization terms into the objective function to impose sparsity in the latent factors. Through another subroutine, the system optimizes the label variables while keeping W and H fixed. This is a combinatorial optimization problem solved using the deterministic annealing technique. The computing system may choose diverse loss functions, regularization terms and optimization techniques to minimize the objective function. To minimize the objective function, the computing system may also employ a non-negative matrix factorization for the one-class collaborative filtering as described below.

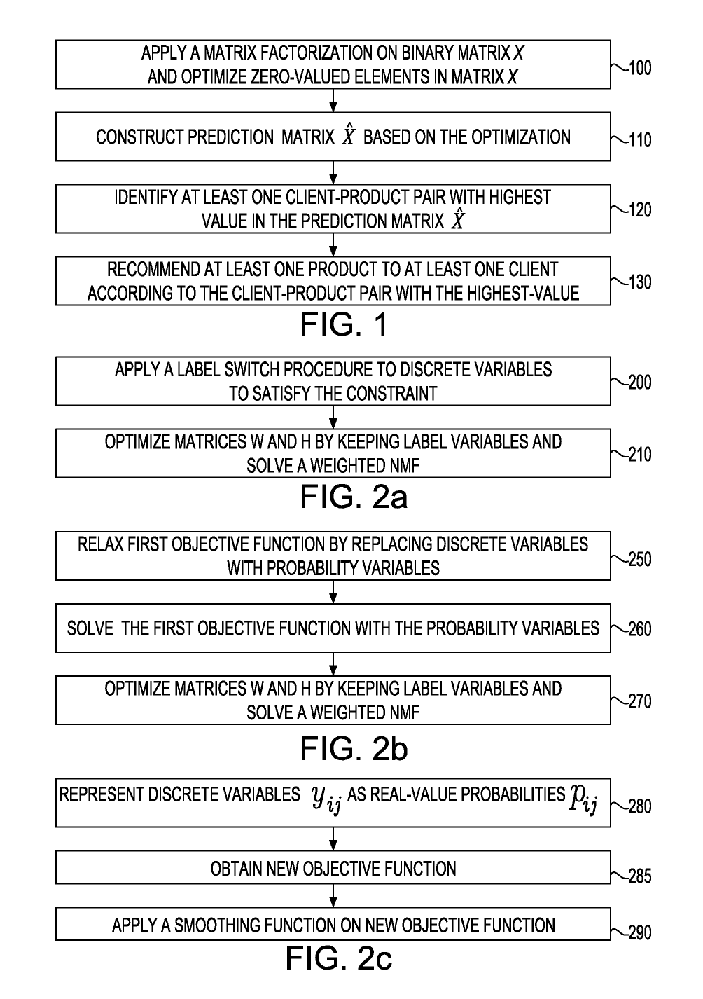

FIG. 1 illustrates a flow chart depicting method steps for automatically recommending a product to a client for a possible future purchase in one embodiment. The computing system retrieves an m×n binary matrix X of data that represents a particular client bought a particular product, e.g., from a corporate database (not shown) or from a storage device (e.g., disk units 321 and tape drives 340 in FIG. 3). The matrix X may be large (e.g., 0.5 million×20,000 entries) and sparse (i.e., having numerous zero-valued elements). A set of non-zero elements, i.e., S={(i, j): Xᵢⱼ=1}, denotes client-product purchases. Xᵢⱼ=0, denotes that no purchase was made, but is not strictly a negative value. The notation S̅={(i, j): Xᵢⱼ=0} is used to denote the complement of S, i.e., client-product pairs representing no purchases.

According to a matrix factorization, clients and products can be represented in an unknown lower-dimensional feature vector where features correspond to latent variables. By applying the matrix factorization on the matrix X, the computing system obtains the client matrix W and the product matrix H. The client matrix W=[w₁, . . . , wₘ]^{T} represents an m×k matrix whose ith row, wᵢ, is the k dimensional representation of a client. Similarly, the product matrix H=[h₁, . . . , hₙ] be a k×n matrix whose jth column, hⱼ, is the k-dimensional representation of a product.

At step 100 in FIG. 1, the computing system applies a weighted non-negative matrix factorization (NMF) on the client-product matrix X, and simultaneously or sequentially optimizes zero-valued elements in the matrix X that correspond to unknown client-product affinities. The optimization is represented, e.g., by equation (1), equation (2) and/or equation (3) described below. Applying the weighted NMF on the matrix X results in a client matrix W that represents clients and a product matrix H that represents products.

$${arg min}_{W \geq 0 , H \geq 0} λ {‖ W ‖}_{F}^{2} + γ {‖ H ‖}_{F}^{2} + {\sum }_{( i , j ) ∈ S} {C}_{ij} V ( {X}_{ij} , {w}_{i}^{T} {h}_{j} ) , \qquad ( 1 )$$

where the first two terms are Frobenius norm based regularizers on the latent factors, S is the set of one-valued elements in matrix X, V is a loss function, e.g., a squared loss function V(y, t)=½(t−y)², where y and t are variables that correspond to Xᵢⱼ and wᵢ^{T} hⱼ respectively, a generalized KL (Kullback-Leibler) divergence loss function V(y, t)=y log(y/t)−y+t, a hinge loss function (e.g., a function 800 depicted in FIG. 7), or other loss function for a matrix factorization. For flexibility, the computing system allows entry specific costs Cᵢⱼ that is larger than or equal to zero. By using these entry specific costs, the computing system can determine the influence of each entry on the matrix factorization. For instance, assume that C₁₃=0.8 and C₄₅=0.1. Then when the computing system performs the matrix factorization, the optimization of the zero-valued elements will force the data entry corresponding C₁₃ to have a smaller reconstruction error than the data entry corresponding to C₄₅. Practically, the computing system uses the entry specific costs to put more emphasis on entries whose values are larger than or equal to 1, i.e., past purchases. Since the computing system does not know the exact interpretation of the zero-valued elements in the matrix X whereas one-valued elements definitely mean that corresponding clients are interested in corresponding products by buying them, the computing system may give more weight (larger Cᵢⱼ) to positive entries so that the factorization will be compatible with the positive entries. The real-valued parameters γ≧0 and γ≧0 tradeoff regularizers (i.e., regularization terms; e.g., first two terms in equation (1)) against data-fit terms. Data-fit terms are components in an objective function which are related to an accuracy of a model which is being fit to. For example, in the equation (1), the third component,

$${\sum }_{( i , j ) ∈ S} {C}_{ij} V ( {X}_{ij} , {w}_{i}^{T} {h}_{j} ) ,$$

is the data-fit term, since it measures the accuracy of the model by using the loss function V(Xᵢⱼ,wᵢhⱼ). For instance, if V gives a small value (e.g., a value less than a pre-determined threshold), then the model successfully fits to the data (e.g., client-product pairs).

In one embodiment, the equation (1) can also be solved without non-negativity constraints, which leads to weighted SVD-like solutions for the squared loss. SVD (Singular Value Decomposition) refers to a factorization of a rectangular real or complex matrix. Andras A. Benczur, et al., “Who Rated What: a combination of SVD, correlation and frequent sequence mining”, KDDCup.07, August 2007, wholly incorporated by reference as if set forth herein, describes SVD in detail. However, a compliance with non-negative constraint may lead to the “part-based” interpretation. In one embodiment, the computing system adds Frobenius norm, i.e., l₂ regularizers, in the objective function (e.g., equation (1)). In another embodiment, the computing system adds l₁ regularizers, i.e., penalization of ∥W∥₁=Σ_{i,j} Wᵢⱼ, ∥H∥₁=Σ_{i,j} Hᵢⱼ with minor modifications to the multiplicative update steps detailed below. Andrew Y. Ng, “Feature selection, L₁ vs. L₂ regularization, and rotational invariance”, Proceedings of the 21^{st} International Conference on Machine Learning, 2004, wholly incorporated by reference as if set forth herein, describes l₁ and l₂ regularizers in detail.

A hinge loss is a type of loss function which does not penalize symmetrically. For example, FIG. 7 plots several exemplary loss functions. A function 800 shows a hinge loss function associated with a variable z. In FIG. 7, if z (a variable of a hinge loss function) is larger than 1 (810), the loss function 800 gives no error or penalty. On the other hand, as z get smaller than 1 (810), the error (shown in the y-axis as E(z)) increases linearly. Thus, if the function being used outputs z as 1 or a larger value, the result of the function will be considered as correct, whereas if the outcome is smaller than 1, the loss function 800 will give an error value depending on the value of z. So, the computing system may attempt to minimize this error to get a correct z value.

To optimize the zero-valued elements in the matrix X corresponding to unknown entries in the matrix X, the computing system treats the zero-valued elements as elements whose values are missing and/or as optimization variables (i.e., variables to be optimized). The equation (1) above, equation (2) below and equation (3) below are objective functions representing the optimization. The computing system may attempt to minimize one or more of these objective functions for the optimization. At step 110, based on the matrices W and H and/or the optimization performed at step 100, the matrix X is reconstructed as a prediction matrix \hat{X}=WH. Each element value in the prediction matrix \hat{X} represents a likelihood that a corresponding client purchases a corresponding product.

In another embodiment, to optimize the zero-valued elements corresponding to unknown entries in the matrix X, the computing system treats the zero-valued elements as elements that reflect low affinities (e.g., no prior purchases) between the corresponding client and product. In this embodiment, the objective function is represented by

$${argmin}_{W \geq 0 , H \geq 0} λ {‖ W ‖}_{F}^{2} + γ {‖ H ‖}_{F}^{2} + {\sum }_{( i , j ) ∈ S} {C}_{ij} V ( 1 , {w}_{i}^{T} {h}_{j} ) + {\sum }_{( i , j ) ∈ \overline{S}} {C}_{ij} V ( 0 , {w}_{i}^{T} {h}_{j} ) , \qquad ( 2 )$$

where S̅ represents the complement of S, i.e., Xᵢⱼ elements whose values are zero. As one optimization, the computing system attempts to minimize the equation (2) which is the objective function in this embodiment. The equation (2) assigns zero values to products that a client has not bought before. In other words, the lack of purchase in the past is taken as evidence for low affinity. In a further embodiment, the computing system may control contribution of each element Xᵢⱼ to the equation (2), e.g., by assigning a uniform, user-specific or product-specific weight (Cᵢⱼ) to each element Xᵢⱼ.

In another embodiment, the computing system considers the zero-valued elements (i.e., unknown entries in the matrix X) as optimization variables (i.e., variables to be optimized). In this embodiment, the computing system solves an equation (3) to optimize the zero-valued elements.

$${argmin}_{{W \geq 0 , H \geq 0}_{{y}_{ij} ∈ \{ 0 , 1 \} , ( i , j ) ∈ \overline{S}}} J ( W , H , {\{ {y}_{ij} \}}_{( i , j ) ∈ \overline{S}} ) = λ {‖ W ‖}_{F}^{2} + γ {‖ H ‖}_{F}^{2} + {\sum }_{( i , j ) ∈ S} {C}_{ij} V ( 1 , {w}_{i}^{T} {h}_{j} ) + {\sum }_{( i , j ) ∈ \overline{S}} {C}_{ij} V ( {y}_{ij} , {w}_{i}^{T} {h}_{j} ) , \qquad ( 3 )$$

where J(W, H, {yᵢⱼ}_{(i,j)ε S̅}) denotes a first objective function that represents the optimization of the zero-valued elements. In the first objective function, two optimization variables are the latent factors, W, H, while yᵢⱼ are discrete variables (i.e., binary variables) that represents one-valued elements and zero-valued elements in the matrix X (set S̅). In other words, yᵢⱼ=1 implies a positive class (i.e., a client i purchased a product j), while yᵢⱼ=0 implies a negative class (i.e., a client i did not purchase a product j). In the first objective function, the zero-valued elements are optimization variables whose values are uncertain and therefore the optimization variables yᵢⱼ need to be optimized.

In a further embodiment, the computing system solves the first objective function under a constraint. The constraint includes, but is not limited to, that a certain fraction of the optimization variables yᵢⱼ are positive:

$$\frac{1}{\vert \overline{S} \vert} {\sum }_{( i , j ) ∈ \overline{S}} {y}_{ij} = r , \qquad ( 4 )$$

where r will be a user-specified parameter.

In the equation (4), if r is set to zero, then yᵢⱼ becomes zero, where (i, j) belongs to S̅, and the equation (3) becomes the equation (2). If Cᵢⱼ is set to zero, where (i, j) belongs to S̅, the equation (3) becomes the equation (1). The computing system minimizes the first objective function to optimize the zero-valued elements (set S̅) in the matrix X under the constraint (e.g., the equation (4)).

Returning to FIG. 1, at step 120, the computing system identifies at least one client-product pair with the highest value elements in the matrix \hat{X}. At step 130, the computing system recommends at least one product to at least one client according to the client-product pair with the highest value. For example, the computing system recommend a product corresponding to the highest value element(s) in the matrix \hat{X} to a client corresponding to the highest value element(s) in the matrix \hat{X}.

The first objective function has a mix of continuous and discrete variables, i.e., it has two matrices having continuous variables, WεR^{m×k} and HεR^{k×n}, and a collection of discrete variables yᵢⱼ ε {0, 1} that represent one-valued elements and zero-valued elements in the matrix X. For optimizing W and H, while keeping a set of yᵢⱼ variables fixed, the computing system applies a weighted non-negative matrix factorization on the matrix X to obtain the matrices W and H. For example, the computing system maps rows or columns of the matrix X that correspond to clients into the matrix W. Similarly, the computing system maps rows or columns of the matrix X that correspond to products into the matrix H. The computing system utilizes an “alternating” optimization over W keeping H fixed, and vice versa. It is referred herein as the “alternating” optimization because while keeping one variable fixed, the computing system optimizes the other variable. This alternating optimization is a convex problem. A function is convex if all the points on or above the function is a convex set. A set is convex if every point on a straight line segment that joins any pair of points in that set is also within the set. For the weighted NMF, the computing system may use multiplicative update steps, projected gradient technique and other methods. Multiplicative update steps are described below in detail. Chih-Jen Lin, “Projected Gradient Methods for Non-negative Matrix Factorization”, Neural Computation, 2007, wholly incorporated by reference as set forth herein, describes the projected gradient technique in detail.

In sub-optimizing where yᵢⱼ, where (i, j) ε S̅ and while keeping W and H fixed, yᵢⱼ values are given by

yᵢⱼ=0 if V(0,wᵢ^{T}hⱼ)<V(1,wᵢ^{T}hⱼ), yᵢⱼ=1 otherwise. (5)

FIG. 2a is a flow chart describing method steps for optimizing the zero-valued elements in the matrix X in another embodiment. At step 200 in FIG. 2a, the computing system optimizes the label variables, e.g., by using a label switching procedure. In order to satisfy the constraint, equation (4), the computing system implements a label switching procedure described below. Starting from setting that the zero-valued elements as missing or lost elements, client-product pairs (i, j)ε S̅ are ranked by wᵢ^{T}hⱼ and the corresponding yᵢⱼ of the highest r| S̅| are re-set to a value of “1.” This ranking and re-setting give an initial setting for yᵢⱼ, (i, j)ε S̅. Then, the computing system applies a label switching sub-routine to (locally) optimize yᵢⱼ variables. An equation (6) describes an exemplary label switching sub-routine: Let (a, b) and (c, d) be two client-product pairs such that,

y_{ab}=1, y_{cd}=0 C_{ab}V(1,wₐ^{T}h_{b})+C_{cd}V(0,w_{c}^{T}h_{d})>C_{ab}V(0,wₐ^{T}h_{b})+C_{cd}V(1,w_{c}^{T}h_{d}) (6)

If the above condition (i.e., equation (6)) is satisfied, then swapping the labels, i.e., setting y_{ab}=0, y_{cd}=1 leads to a decrease in the first objective function, while continuing to satisfy the constraint, i.e., equation (4). After the label swap, the computing system re-solves the equation (3) with new label to start the optimization (e.g., decrease the equation (3)) from the previous values of W and H leading to further decrease. At step 210, the computing system optimizes the matrices W and H, e.g., by keeping label variables in the first objective function fixed and applying the weighted NMF technique for different loss functions and regularizers. The computing system may utilize a faster multi-switch heuristic, termination criteria and SVM (Support Vector Machines) optimization technique to optimize the equation (2) and/or (3). S. Sathiya Keerthi and Vikas Sindhwani, “Large Scale Semi-supervised Linear SVMs”, SIGIR'06, August 2006, wholly incorporated by reference as if set forth herein, describes the SVM optimization technique in detail.

One example of multi-switch heuristics is as follows: Assume that customer-product pair-1 is initialized as 1 and pair-2 is initialized as 0. The computing system first calculates a first error from a loss function by these initializations. Then, the computing system also calculates a second error from the loss function by changing the assignments (i.e. making pair-1 0 and pair-2 1). If the second error is smaller, then the labels of pair-1 and pair-2 are switched. Optimization techniques (i.e., weighted NMF, deterministic annealing, etc.) are generally solved iteratively. Termination criteria are a set of rules that define when to stop these iterations. For example, for the above heuristic, a stopping criterion would be counting the number of label switches. If that counting is smaller than a pre-defined threshold, then the iterations can be stopped.

It is possible to alternate W, H (NMF) optimization with the above settings (i.e., equation (5)) for yᵢⱼ. However, the computing system first needs to satisfy the constraint shown in equation (4) since the equation (5) may lead to suboptimal local minima without satisfying the constraint. FIG. 2b illustrates method steps to optimize the zero-valued elements in the matrix X in one embodiment. At step 250 in FIG. 2b, to reduce these local minima (i.e., to relax the first objective function), the computing system uses the deterministic annealing technique (i.e., a flow chart depicted in FIG. 2c) which replaces the discrete variables yᵢⱼ with continuous probability variable pᵢⱼ. The continuous variable pᵢⱼ changes smoothly through the optimization, which reduces the risk of getting trapped in a sub-optimal solution. pᵢⱼ denotes probability that yᵢⱼ is equal to “1.” The computing system applies a deterministic annealing (i.e., method steps shown in FIG. 2) on the first objective function to convert yᵢⱼ into pᵢⱼ and to smoothly change values of pᵢⱼ. In order to satisfy the constraint, equation (4), the computing system needs to uses a non-linear root-finding procedure, which can be done, e.g., by using a combination of bisection method and Newton-raphson method. Grady Wright, “Nonlinear Root Finding”, Nov. 24, 2004, The University of Utah, wholly incorporated by reference as set forth herein, describes the non-linear root-finding procedure in detail. Bisection method is a known root-finding method which continuously divides an interval and chooses a subinterval in which a root may reside. Newton-raphson method is a known method for finding continuously better approximations to zeroes (or roots) of a function. At step 260, the computing system solves the first objective function with the probability variables while by keeping the matrices W and H fixed and using the non-linear root-finding procedure. At step 270, the computing system optimizes the matrices W and H, e.g., by keeping label variables in the first objective function fixed and applying the weighted NMF technique for different loss functions and regularizers.

FIG. 2c illustrates a flow chart depicting method steps for the deterministic annealing in one embodiment. At step 280, the computing system represents discrete variables yᵢⱼ as real-valued probabilities pᵢⱼ. pᵢⱼ denotes probability that yᵢⱼ is equal to “1.” Instead of optimizing the first objective function with respect to yᵢⱼ, the computing system optimizes (e.g., decreases) the expected value of the first objective function under the probabilities pᵢⱼ.

At step 285, the computing system obtains a new objective function by reducing the expected value of the first objective function. At step 290, the computing system applies a smoothing function to the new objective function. If a smoothing parameter (i.e., a parameter in the smoothing function) is varied, the computing system solves the first objective function in an increasing difficulty (e.g., in an increasing number of terms). FIG. 5 illustrates exemplary smoothing functions (e.g., a smoothing function 500 with zero-valued smoothing parameter, a smoothing function 510 with a smoothing parameter whose value is small (e.g., less than 0.5, etc.), a smoothing function 510 with a smoothing parameter whose value is large (e.g., larger than 0.5, etc.). Homotopy refers to a smooth deformation of an objective function.

By applying steps 280-290 to the first objective function, the first objective function becomes an equation (7):

$${argmin}_{W \geq 0 , H \geq 0 , {\{ {p}_{ij} \}}_{( i , j ) ∈ \overline{S}}} {J}_{T} ( W , H , {\{ {p}_{ij} \}}_{ij ∈ S} ) = λ {‖ W ‖}_{F}^{2} + γ {‖ H ‖}_{F}^{2} + {\sum }_{( i , j ) ∈ S} {C}_{ij} V ( 1 , {w}_{i}^{T} {h}_{j} ) + {\sum }_{( i , j ) ∈ \overline{S}} {C}_{ij} ( {p}_{ij} V ( 1 , {w}_{i}^{T} {h}_{j} ) + ( 1 - {p}_{ij} ) V ( 0 , {w}_{i}^{T} {h}_{j} ) ) - T {\sum }_{( i , j ) ∈ S} H ( {p}_{ij} ) subject to \text{:} \frac{1}{\vert \overline{S} \vert} {\sum }_{ij} {p}_{ij} = r \qquad ( 7 )$$

The third line in the equation (7) represents an expected loss under the probabilities pᵢⱼ. The last term H(p)=−p log(p)−(1−p) log(1−p) is a smoothing function measuring entropy. When T is high (e.g., T>100), the entropy is maximized at pᵢⱼ=r. This corresponds to essentially solving a softer version of equation (2) by letting the zero-valued elements be r. As T is decreased, pᵢⱼ can be shown to progressively approach to discrete variables.

In one embodiment, the computing system uses an alternating optimization procedure to minimize the equation (7): First, assume that T is fixed. The computing system optimizes W and H, while keeping pᵢⱼ is fixed, e.g., by applying a weighted NMF on W and H. Then, while keeping W and H fixed, the computing system optimize pᵢⱼ under the constraint. This optimizing of pᵢⱼ is a convex problem described above. Following describes these steps in detail for the squared loss, e.g., V (t, y)=½(t−y)².

For fixed p, the optimization over W and H involves the first four terms of equation (7). This optimization over W and H can be written as,

$${arg min}_{W , H} λ {‖ W ‖}_{F}^{2} + γ {‖ H ‖}_{F}^{2} + {‖ K ⊗ ( X - WH ) ‖}_{F}^{2} + {\sum }_{ij} {C}_{ij} [ {{p}_{ij} ( 1 - {w}_{i}^{T} {h}_{j} )}^{2} + ( 1 - {p}_{ij} ) {( {w}_{i}^{T} {h}_{j} )}^{2} ] \qquad ( 8 )$$

where [symbol] denotes element-wise product and the matrix K is given by Kᵢⱼ=\sqrt{Cᵢⱼ}. With re-arrangements, the computing system obtains the solution to the equation (8), e.g., by solving

$${arg min}_{W , H} λ {‖ W ‖}_{F}^{2} + γ {‖ H ‖}_{F}^{2} + {‖ K ⊗ ( U - WH ) ‖}_{F}^{2} \qquad ( 9 )$$

where U=X+P, P being a matrix whose elements equal to pᵢⱼ when (i, j)ε S̅ and 0 when (i, j) εS. Thus, the optimization on (i.e., minimizing of) W and H for fixed pᵢⱼ is a weighted NMF problem of equation 9. The computing system obtains the solution of equation (9), e.g., by alternating between the following two multiplicative update steps,

$$\begin{matrix}H = H ⊗ \frac{{W}^{T} ( K ⊗ U )}{{W}^{T} ( K ⊗ ( WH ) ) + γ H} & ( 10 ) \\ W = W ⊗ \frac{( K ⊗ U ) {H}^{T}}{( K ⊗ ( WH ) ) {H}^{T} + λ W} & ( 11 )\end{matrix}$$

where division is elementwise.

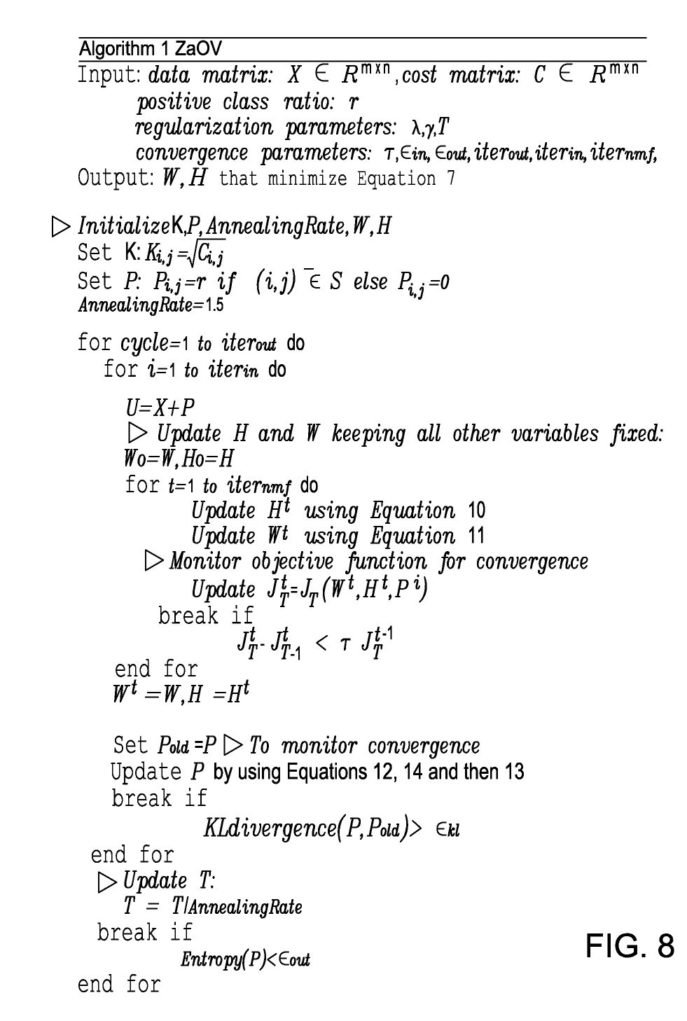

Algorithm 1 shown in FIG. 8 illustrates how the computing system can implement the optimizing the equation (7) in one embodiment. The computing system starts iterations from previous values of W and H maintained in an outer loop (“for cycle=1 to iterₒᵤₜ do” and “for i=1 to iterᵢₙ do”) or from random matrices or other sources if the outer loop is being run. Once inside an inner loop (“for t=1 to iter_{nmf} do”), the computing system repeats multiplicative update steps (i.e., steps in equations 10 and 11) until a convergence criterion is satisfied. The convergence criteria include, but are not limited to: a relative decrease in an objective function value falls below a user-specified threshold. Alternatively, the computing system repeats the multiplicative update steps until a maximum number of iterations are exceeded. With modifications to the update steps above, the computing system can handle other loss functions, e.g., a generalized KL-divergence and other regularizers, e.g., l₁ norm of W and H. After completing the optimization over W and H, the computing system optimizes pᵢⱼ, over fixed W and H. This optimization on pᵢⱼ updates P, e.g., by using the equations (12)-(14) shown below.

The optimization on pᵢⱼ involves the forth and fifth terms in the equation (7) under the constraint: (1) Let v be a Lagrange multiplier (i.e., a method for finding the maximum/minimum of a function subject to a constraint) corresponding to the constraint. (2) Define

gᵢⱼ=Kᵢⱼ[V(l,oᵢⱼ)−V(0,oᵢⱼ)] (12),

where oᵢⱼ refers to wᵢ^{T} hⱼ.
By forming the Lagrange multiplier and setting its gradient to “0,” pᵢⱼ can become

$${p}_{ij} = \frac{1}{1 + {e}^{\frac{{g}_{ij} - v}{T}}} \qquad ( 13 )$$

where v can be found by substituting the constraint described in equation (4) with an equation (14) and solving the equation (14).

$$\frac{1}{\vert \overline{S} \vert} {\sum }_{ij ∈ \overline{S}} \frac{1}{1 + {e}^{\frac{{g}_{ij} - v}{T}}} = r \qquad ( 14 )$$

For a fixed value of T, we optimize W and H and pᵢⱼ variables using the alternating optimization scheme described above, e.g., Algorithm 1 shown above. This alternating optimization involves repeatedly running equations (10), (11) and (13) until a termination criterion (e.g., a maximum number of iterations are performed, etc.) is satisfied. The performance of Algorithm 1 at a fixed value of T is described below and the sensitivity to this choice (i.e., T's value) with respect to recommendation quality is described below.

In one embodiment, Algorithm 1 starts from a high value of T, e.g., T larger than 100. Then, the entropy of pᵢⱼ dominates the equation (7) (i.e., an objective function modified from the equation (3) by performing the deterministic annealing (method steps in FIG. 2) on the equation (3)) and a corresponding solution under the constraint is obtained by setting pᵢⱼ=r. The optimization over W and H then solves the equation (2) where zeros are replaced by r. As T is reduced at a rate specified by an annealing rate parameter, pᵢⱼ variables begin to harden (i.e., be close to 0 or 1) and behave as discrete variables, but their optimizations are initialized from a solution of the equation (7) obtained at the high value of T.

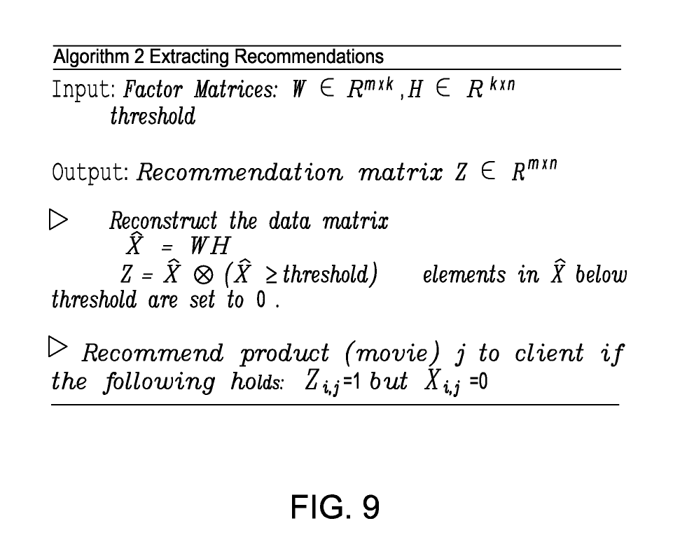

A gradual reduction of T may be seen as solving the equation (7) as slowly shrinking the effect of a regularizer parameterized by T. The computing system may stop the inner loop in Algorithm 1 that minimizes the equation (7) based on the KL divergence between successive values of pᵢⱼ, while the computing system may stop the outer loop based on net entropy of pᵢⱼ variables. KL divergence is a non-symmetric measure of the difference between two probability distributions. Once the factor matrices (i.e., W and H) are updated, the prediction matrix (i.e., X̅) is reconstructed and thresholded to extract (client, product) recommendations (see Algorithm 2 in FIG. 9).

In one embodiment, the computing system re-arranges the alternating optimization (i.e., Algorithm 1) so that pᵢⱼ variables are re-optimized after each W and H update. Secondly, while the computing system applies the determining annealing and smooth deformation to obtain the equation (7) with respect to pᵢⱼ variables alone, the computing system can apply the deterministic annealing and smooth deformation for W and H also. One way to perform this annealing and smooth deformation on W and H is to gradually reduce λ and γ starting from large values (e.g., 0.5) to their final values (e.g., 0.0001). The degree of non-convexity (i.e., the degree that does not satisfy the convexity) of the first objective function can potentially be controlled along multiple dimensions in the annealing process. In one embodiment, the computing system may want to avoid explicitly optimizing all (i, j) variables in S̅, but rather work with a smaller subset. Such a subset can be randomly chosen. In one embodiment, the computing system may choose the regularization terms and the constraint in a manner using procedures like cross-validation.

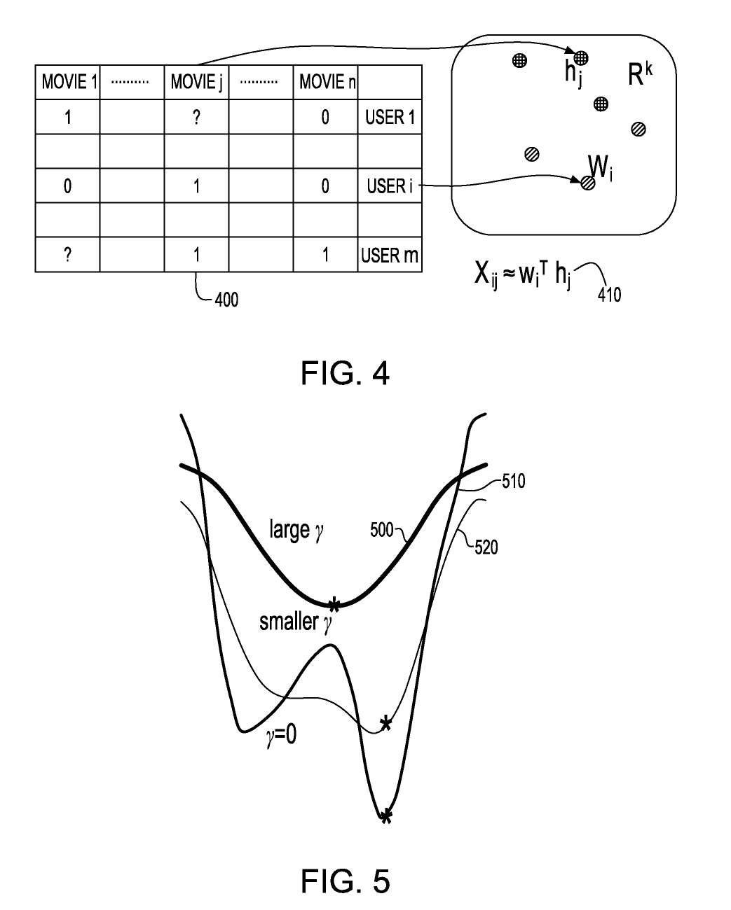

Following describes an exemplary scenario using Algorithms 1 and 2. The computing system conducted experiments on theMovieLens dataset available at: http://www.grouplens.org/system/files/ml-data_{—}0.zip. The dataset consists of 100,000 ratings on an integer scale from 1 to 5 given to 1642 movies by 943 users. To simulate one-class experiments, the computing system removed all 3 and below ratings, relabeled ratings 4 and 5 as 1, and then obtained a binary customer-movie matrix (e.g., matrix 400 in FIG. 4). In this example, the binary customer-movie matrix includes random training-test splits of positive customer-movie pairs in the ratio 60%-to-40% respectively.

There is a trade-off between precision and recall; generally (not necessarily) one of them will increase while the other decreases. Precision-recall curve plots the value of precision-recall pairs for different thresholds that are used to acquire these values. Precision is used as y-axis and recall is put to x-axis. For instance, assume that there are 100 patients, 10 of which have cancer and the computing system is trying to find these 10 people. Further assume that the computing system makes 4 prediction of which 3 are correct, then precision=0.75 and recall=0.3. But as the computing system starts to make more predictions, the recall will increase while the precision will decrease. The computing system computes precision-recall curves in the following manner. After updating W and H from Algorithm 1, the computing system extracts recommendations from Algorithm 2 at a pre-defined threshold. At that threshold, the computing system computes the following quantities:

$$Precision = \frac{\# TestSetHits}{\# Recommendations}$$

$$Recall = \frac{\# TestSetHits}{\# TestSetPositives}$$

where #Recommendations is the number of user-movie recommendations made, #TestSetHits is the subset of recommended user-movie pairs that are one-valued in the test set (these numbers depend on the recommendation threshold), and #TestSetPositives is the number of ones in the test set. The computing system reports the Area under the Precision-Recall Curves (abbreviated as AUC) generated as the recommendation threshold is varied.

The computing system compares one-class approaches (e.g., equations (1) and (2)) with the following approaches. The computing system applies the one-class approaches with NMF. The one-class approaches includes, but is not limited to:
1. ZAM: Ignoring zero-valued elements in the matrix X, i.e., solving the equation (1) with Cᵢⱼ=1 for i,jεS and Cᵢⱼ=0 for i,jε S̅
2. ZAN: Treating the zero-valued elements as negative examples that represent no prior purchase, i.e., solving the equation (2) with Cᵢⱼ=1, 1≦i≦m, i≦j≦n
3. wZAN (uniform): a weighted version of ZAN where zeros are treated as negative examples but a uniform weight with a value δₖ that is less than 1 is additionally imposed (i.e., Cᵢⱼ=1, where (i,j)εS and Cᵢⱼ=δₖ, where (i,j)ε S̅ in the last term of equation (2)). This weighting implements an intuition that the confidence of unknown labels being negative is lower than the confidence of positive labels. In particular, the computing system reports the best performance over the following weights

$${δ}_{k} = \frac{{n}_{+}}{{2}^{k} {n}_{0}} \qquad ( 15 )$$

where n₊ are the number of positive labels, and n₀ are the number of zero-valued elements in X, with k being equal to 0 or close to 0.
4. wZAN (item-oriented): Here, the weights are not uniform and the j^{th} item/column has its own weight proportional to m−ΣᵢXᵢⱼ. In a sales recommendation setting, wZAN (item-oriented) may impose product-specific weights, and for movie recommendation, it may impose movie-specific weights. In wZAN (item-oriented), the computing system reports the best performance over weights ∀j: Cᵢⱼ=δₖ(m−ΣᵢXᵢⱼ), k=0, 1, 2, 3 where δₖ is the same as defined in equation (15) for wZAN (uniform). wZAN (item-oriented) implements an intuition that if an item has less number of positive-valued (e.g., “1”) elements, the missing elements for this item have negative values with higher probability.
5. wZAN (user-oriented): Here, the weights are not uniform and the i^{th} user/row has its own weight proportional to ΣᵢXᵢⱼ. In a sales recommendation setting, wZAN (user-oriented) may impose client-oriented weights, and for a movie recommendation, wZAN (user-oriented) may impose user-specific weights. In wZAN (user-oriented), the computing system reports the best performance over the following weights ∀j: Cᵢⱼ=δₖΣᵢXᵢⱼ, k=0, 1, 2, 3 where δₖ is the same as defined for wZAN (uniform). wZAN (user-oriented) implements an intuition that a user has more number of positive-valued elements for an item, it is more likely that other items are less preferred, that is, the missing elements for this user (client) have negative values with higher probability.
6. “Popularity”: In this scheme, each client-item pair is ranked based on a popularity of each item (number of clients who purchased it) and a purchase volume of each client (number of products bought). Then a client-product pair (i, j) is ranked as follows, rank(i, j)=(#clients)[rank(i)−1]+rank(j). Recommending based on this ranking attempts to sell products (in the order of their popularities) to clients (in the order of their loyalties).

In Table 1, the computing system reports the area under the precision recall curve (“AUC”) for each of the six approaches and compares them with Algorithms 1 and 2 for three choices of NMF rank. For simplicity, for all approaches, the computing system chose γ=λ=0. All approaches were initialized from the same initial random W and H. For wZAN with uniform, item-oriented and user-oriented weightings, the computing system optimized the value of δₖ in equation (15) over the equation (7), where 0≦k≦6, for example.

TABLE 1
Comparison of all methods in terms of Area under Precision-Recall Curve

| Methods | rank = 5 | rank = 10 | rank = 15 |
|---|---|---|---|
| ZAM | 1.10 ± 0.09 | 1.42 ± 0.14 | 1.44 ± 0.19 |
| Popularity | 2.29 ± 0.11 | 2.29 ± 0.11 | 2.29 ± 0.11 |
| ZAN | 25.09 ± 0.24 | 26.05 ± 0.33 | 24.37 ± 0.28 |
| wZAN (uniform) | 24.38 ± 0.37 | 25.47 ± 0.47 | 24.03 ± 0.49 |
| wZAN (item based) | 25.45 ± 0.63 | 27.17 ± 0.60 | 26.39 ± 0.59 |
| wZAN (user based) | 16.36 ± 0.22 | 16.98 ± 0.34 | 17.05 ± 0.46 |
| ZoAV (proposed) | 26.33 ± 0.65 | 28.09 ± 0.71 | 27.36 ± 0.54 |

As shown in Table 1 above, since ZAM only uses the positive-valued elements, ZAM returns the worst performance (i.e., the lowest value of AUC). ZAM is outperformed by the “Popularity.” ZAN performs substantially better than ZAM and “Popularity.” The performance of wZANs becomes the worst with user-oriented weighting, but improves with item-oriented weighting. Finally, initializing from the best approach (wZAN (item-oriented)), an optimization using Algorithms 1 and 2 produces the best performance among all seven methods compared in Table 1.

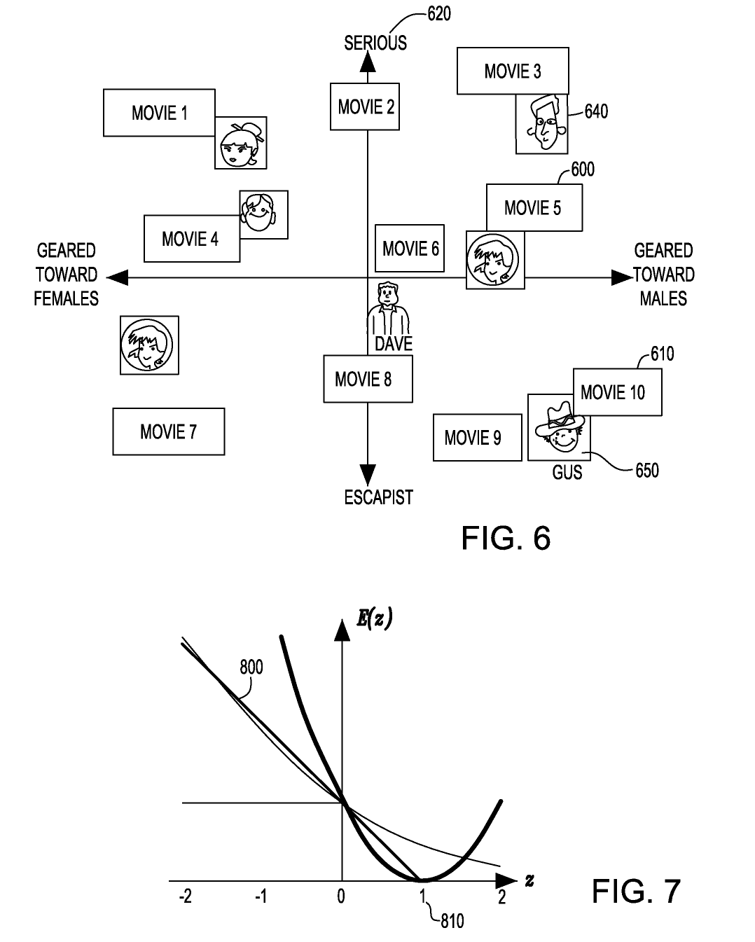

Interpretability is an important concern as sellers and marketers not only need to act on a recommendation but also have some sense of how to “pitch” a product. Uninterpretable recommendations are more likely to be dismissed as not being well-tailored to the needs of a client or the specification of a product. FIG. 6 illustrates exemplary movie recommendations made based on the factor models. According to FIG. 6, the computing system makes different movie recommendations (e.g., movies 600 and 610, etc.) to different people (e.g., a first person 640, a second person 650, etc.) according to their preferences (e.g., seriousness 620, etc.) and nature (e.g., man 630, etc.).

In one exemplary embodiment, for Algorithms 1 and 2, the computing system may use the following internal optimization parameters: iterᵢₙ=40, iterₒᵤₜ=1, iter_{nmf}=100, εₒᵤₜ=10⁻⁸, εᵢₙ=10⁻⁶, τ0.0001. The computing system may also use the following parameters: T=30, r=0.1. For example, keeping T fixed at 30, the computing system reports performance sensitivity to r in Table 2.

TABLE 2
Sensitivity to r

| | r | | | | | |
|---|---|---|---|---|---|---|
| | 0.01 | 0.05 | 0.1 | 0.2 | 0.3 | 0.7 |
| AUC | 0.2788 | 0.2825 | 0.2859 | 0.2849 | 0.2819 | 0.1528 |

Similarly, keeping r fixed at 0.1, the computing system reports performance sensitivity with respect to choice of T in Table 3. Thus, Algorithm 1 tends to be robust to the selection of r, as the performance is stable for rε[0.05, 0.3]. Large values of r (e.g., r=0.7, etc.) bias the Algorithm 1 towards filling up large portions (e.g., more than ½, etc.) of the missing elements with ones, which does not suit the sparse nature of the collaborative filtering. With regards to sensitivity with respect to choice of T, Algorithm 1 returns similar performance for various values of T.

TABLE 3
Sensitivity to T

| | T | | | | |
|---|---|---|---|---|---|
| | 10 | 50 | 100 | 1000 | 10000 |
| AUC | 0.2878 | 0.2891 | 0.2867 | 0.2887 | 0.2881 |

Algorithms 1 and 2 use a principled, novel optimization approach to one-class collaborative filtering. Algorithms 1 and 2 may use non-convex optimization techniques in a context of transductive SVMs for semi-supervised learning. Algorithm 1 jointly uses a non-negative matrix factorization technique for collaborative filtering while optimizing for unknown discrete label variables. As shown in Table 1, Algorithms 1 and 2 give statistically significant improvements over six competing alternatives for one-class collaborative filtering with non-negative matrix factorizations.

FIG. 3 illustrates an exemplary hardware configuration of a computing system 200 running and/or implementing the method steps in FIGS. 1-2. The hardware configuration preferably has at least one processor or central processing unit (CPU) 311. The CPUs 311 are interconnected via a system bus 312 to a random access memory (RAM) 314, read-only memory (ROM) 316, input/output (I/O) adapter 318 (for connecting peripheral devices such as disk units 321 and tape drives 340 to the bus 312), user interface adapter 322 (for connecting a keyboard 324, mouse 326, speaker 328, microphone 332, and/or other user interface device to the bus 312), a communication adapter 334 for connecting the system 300 to a data processing network, the Internet, an Intranet, a local area network (LAN), etc., and a display adapter 336 for connecting the bus 312 to a display device 338 and/or printer 339 (e.g., a digital printer of the like).

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with a system, apparatus, or device running an instruction.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with a system, apparatus, or device running an instruction.

Program code embodied on a computer readable medium may be transmitted using any appropriate medium, including but not limited to wireless, wireline, optical fiber cable, RF, etc. or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may run entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which run via the processor of the computer or other programmable data processing apparatus, create means for implementing the functions/acts specified in the flowchart and/or block diagram block or blocks. These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which run on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more operable instructions for implementing the specified logical function(s). It should also be noted that, in some alternative implementations, the functions noted in the block may occur out of the order noted in the figures. For example, two blocks shown in succession may, in fact, be run substantially concurrently, or the blocks may sometimes be run in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for automatically presenting at least one product to at least one client for at least one possible purchase, the method comprising:
applying a matrix factorization on a matrix X representing which clients purchased which products;
optimizing zero-valued elements in the matrix X that correspond to unknown client-product affinities;
constructing, based on the optimization of the matrix X, a prediction matrix \hat{X} whose each element value represents a likelihood that a corresponding client purchases a corresponding product;
identifying at least one client-product pair with a highest value in the matrix \hat{X}; and
recommending at least one product to at least one client according to the client-product pair with the highest value,
wherein a processor performs one or more of: the applying, the optimization, the constructing, the identifying and the recommending.

2. The method according to claim 1, further comprising:
creating, from the matrix X, a client matrix W for representing clients and a product matrix H representing products,
wherein the prediction matrix \hat{X} is constructed by multiplying the client matrix W and the product matrix H.

3. The method according to claim 2, wherein the optimizing includes:
formulating a first objective function representing the optimization, the function comprising terms including the matrix W, the matrix H, and discrete variables that represents one-valued elements and the zero-valued elements in the matrix X; and
minimizing the first objective function under a constraint.

4. The method according to claim 3, wherein the constraint includes that a fraction of the discrete variables is positive.

5. The method according to claim 4, wherein the optimization further comprises:
applying a label switch procedure to the discrete variables to satisfy the constraint, the label switch procedure switching values of two different discrete variables if a certain condition associated with the two different discrete variables are met; and
optimizing the matrices W and H by keeping label variables in the first objective function fixed and solving a weighted NMF (Non-negative Matrix Factorization) for different loss functions and regularizers.

6. The method according to claim 3, wherein the optimization further comprises:
relaxing the first objective function by replacing the discrete variables in the first objective function with probability variables;
solving the first objective function for the probability variables in the first objective function by keeping the matrices W and H fixed and using a non-linear root-finding procedure; and
optimizing the matrices W and H by keeping label variables in the first objective function fixed and solving a weighted NMF for different loss functions and regularizers.

7. The method according to claim 6, further comprising:
obtaining a new objective function by reducing an expected value of the first objective function with the probability variables; and
applying a smoothing function to the new objective function.

8. The method according to claim 6, wherein the weighted NMF includes a multiplicative update step for the matrix W and a multiplicative update step for the matrix H.

9. The method according to claim 8, further comprising:
repeating the multiplicative update steps until a convergence criterion is satisfied; or
repeating the multiplicative update steps for a certain number of iterations.

10. The method according to claim 3, wherein the first objective function includes a regularizer and the optimization includes smoothing the first objective function.

11. The method according to claim 1, wherein the optimization includes:
treating the zero-valued elements as elements whose values are missing.

12. A system for automatically presenting automatically presenting at least one product to at least one client for at least one possible purchase, the system comprising:
a memory device; and
a processor connected to the memory device,
wherein the processor performs step of:
applying a matrix factorization on a matrix X representing which clients purchased which products;
optimizing zero-valued elements in the matrix X that correspond to unknown client-product affinities;
constructing, based on the optimization of the matrix X, a prediction matrix \hat{X} whose each element value represents a likelihood that a corresponding client purchases a corresponding product;
identifying at least one client-product pair with a highest value in the matrix \hat{X}; and
recommending at least one product to at least one client according to the client-product pair with the highest value.

13. The system according to claim 12, wherein the processor further performs:
creating, from the matrix X, a client matrix W for representing clients and a product matrix H representing products,
wherein the prediction matrix \hat{X} is constructed by multiplying the client matrix W and the product matrix H.

14. The system according to claim 13, wherein the optimization includes:
formulating a first objective function representing the optimization, the function comprising terms including the matrix W, the matrix H, and discrete variables that represents one-valued elements and the zero-valued elements in the matrix X; and
minimizing the first objective function under a constraint.

15. The system according to claim 14, wherein the constraint includes that a fraction of the discrete variables is positive.

16. The system according to claim 15, wherein the optimization further comprises:
applying a label switch procedure to the discrete variables to satisfy the constraint, the label switch procedure switching values of two different discrete variables if a certain condition associated with the two different discrete variables are met; and
optimizing the matrices W and H by keeping label variables in the first objective function fixed and solving a weighted NMF (Non-negative Matrix Factorization) for different loss functions and regularizers.

17. The system according to claim 14, wherein the optimization further comprises:
relaxing the first objective function by replacing the discrete variables in the first objective function with probability variables;
solving the first objective function for the probability variables in the first objective function by keeping the matrices W and H fixed and using a non-linear root-finding procedure; and
optimizing the matrices W and H by keeping label variables in the first objective function fixed and solving a weighted NMF for different loss functions and regularizers.

18. The system according to claim 17, further comprising:
obtaining a new objective function by reducing an expected value of the first objective function under the probability variables; and
applying a smoothing function to the new objective function.

19. The system according to claim 17, wherein the weighted NMF includes a multiplicative update step for the matrix W and a multiplicative update step for the matrix H.

20. The system according to claim 19, wherein the processor further performs:
repeating the multiplicative update steps until a convergence criterion is satisfied; or
repeating the multiplicative update steps for a certain number of iterations.

21. The system according to claim 14, wherein the first objective function includes a regularizer and the optimization includes smoothing on the first objective function.

22. The system according to claim 12, wherein the optimization includes:
treating the zero-valued elements as elements whose values are missing.

23. A computer program product for automatically presenting at least one product to at least one client for at least one possible purchase, the computer program product comprising a storage medium readable by a processing circuit and storing instructions run by the processing circuit for performing a method, the method comprising:
applying a matrix factorization on a matrix X representing which clients purchased which products;
optimizing zero-valued elements in the matrix X that correspond to unknown client-product affinities;
constructing, based on the optimization of the matrix X, a prediction matrix \hat{X} whose each element value represents a likelihood that a corresponding client purchases a corresponding product;
identifying at least one client-product pair with a highest value in the matrix \hat{X}; and
recommending at least one product to at least one client according to the client-product pair with the highest value.

24. The computer program product according to claim 23, wherein the method further performs:
creating, from the matrix X, a client matrix W for representing clients and a product matrix H representing products,
wherein the prediction matrix \hat{X} is constructed by multiplying the client matrix W and the product matrix H.

25. The computer program product according to claim 23, wherein the optimization includes:
formulating a first objective function representing the optimization, the function comprising terms including the matrix W, the matrix H, and discrete variables that represents one-valued elements and the zero-valued elements in the matrix X; and
minimizing the first objective function under a constraint.
